(19) United States
(12) Patent Application Publication
(10) Pub. No.: US 2022/0141522 A1
(43) Pub. Date: May 5, 2022

(54) Methods, Systems and Computer Program Products for Integrating a Secondary Interactive Display Datastream with a Primary Display Datastream

(71) Applicant: Bluestack Systems, Inc., Campbell, CA (US)

(72) Inventors: Suman Saraf, Gurugram (IN); Vikram Gupta, Gurugram (IN); Sohil Arora, Gurugram (IN); Mohit Joshi, Udaipur (IN)

(21) Appl. No.: 17/517,212

(22) Filed: Nov. 2, 2021

Related U.S. Application Data
(60) Provisional application No. 63/130,997, filed on Dec. 28, 2020.

(30) Foreign Application Priority Data
Nov. 3, 2020 (IN) 202011047975

(51) Int. Cl. H04N 21/431; G06F 3/14; H04N 21/2187; H04N 21/218; H04N 21/8545

(52) U.S. Cl. CPC H04N 21/4316; G06F 3/1446; H04N 21/8545; H04N 21/21805; H04N 21/2187

(57) ABSTRACT

The present invention relates to display datastream broadcasting technologies. In particular, the present invention relates to methods, systems and computer program products for displaying at one or more display end-points, an integrated display that is generated based on a primary display datastream and a secondary interactive display datastream. In an embodiment, the invention comprises (i) initiating a primary display datastream transmission session with a display end-point, (ii) initiating a secondary interactive display data stream transmission session with the display end point, (iii) implementing simultaneous display of first video content corresponding to a primary display datastream and second video content corresponding to a secondary interactive display data stream on a display device associated with the display end point, (iv) receiving one or more user input control signals, and (v) implementing video content delivery control of the secondary interactive display datastream based on the received user input control signals.

### CROSS-REFERENCE TO RELATED APPLICATIONS

This application claims priority to Indian Patent Application No. 202011047975 filed Nov. 3, 2020, and U.S. Provisional Application 63/130,997 filed Dec. 28, 2020, the disclosures of which are hereby incorporated by reference in their entirety.

### FIELD OF THE INVENTION

The present invention relates to display datastream broadcasting technologies. In particular, the present invention relates to methods, systems and computer program products for displaying at one or more display end-points, an integrated display that is generated based on a primary display datastream and a secondary interactive display datastream.

### BACKGROUND

Data network based streaming of display data, such as streaming video content, to one or more display end-points or display terminals is ubiquitous. On the one hand, there is the incidence of streaming of video content through one or more video streaming service providers—such as YouTube™, Netflix#, Amazon Prime™. On the other, there are gameplay streaming platforms such as Game,TV™, Twitch™ and YouTube™ Gaming Live—which allow one or more video game players (“garners”) to stream the gamer's display data and/or game telemetry data to one or more viewers, thereby enabling such viewers to spectate the gameplay.

FIG. 1 illustrates an exemplary system environment 100 that enables streaming of display data to a plurality of viewers display end-points (i.e. viewer display devices). As shown in FIG. 1, system environment 100 comprises at least a streaming server platform 104, configured to broadcast one or more display datastreams over the internet 108 (or over any other data network) to a plurality of viewers display end-points 106a, 106b, 106c. As shown—each broadcast end-point may comprise a display device controlled by one of viewer 1, viewer 2, upto viewer n (for example, a mobile device, desktop computer device, laptop device etc).

Streaming server platform 104 may comprise a streaming server 104a configured to (i) receive display data such as video data or videostream data from a display data source, (ii) generate and maintain a data channel to each of display end-points 106a to 106c, and (iii) transmit the display data through a display datastream to each such display end-point 106a to 106c over the corresponding data channel. In an embodiment, (for example, an embodiment where the streaming server 104a is streaming a video file)—the display data may be retrieved from a database 104b that is located within, or that is communicatively coupled with, streaming server platform 104. FIG. 2A provides an example of such an embodiment, where an exemplary display datastream 200A comprises a datastream of a video clip of a goat eating video film

In another embodiment, the streaming server 104a may be configured to stream gameplay data from a gamer's system. As shown in FIG. 1, the gamer may be operating within gamer premises 102—wherein the game in question is being played on any one of gaming devices 1022a to 1022d (i.e. a desktop central processing unit (CPU) 1022a, mobile device 1022b, laptop 1022c, or set top box 1022d). As shown, the gamer may provide gameplay inputs through controller(s) 1026 (comprising for example, any one or more of keyboard 1026a, mouse 1026b and or video game controller 1026c), and may have a high definition monitor 1024 connected to the gaming device 1022a to 1022d for an improved game play viewing experience. FIG. 2B provides an example of such an embodiment, where display datastream 200A comprises a gameplay video datastream of a racing game, originating from the gaming device of a gamer streaming under the online name “P@”.

It has been observed that non-participating viewers of display datastreams tend to lose interest in the streaming display data quickly—causing them to stop viewing.

There is accordingly a need to involve viewers of a display datastream in one or more interactive activities that promote viewer engagement and participation while simultaneously enabling the viewer to continue to view the display datastream.

The invention provides methods, systems and computer program products for generating and displaying at one or more display end-points, an integrated display that is generated based on a primary display datastream and a secondary interactive display datastream.

### SUMMARY

The present invention provides methods, systems and computer program products for displaying at one or more display end-points, an integrated display that is generated based on a primary display datastream and a secondary interactive display datastream.

In an embodiment, the invention provides a method for delivering videostream data at a display end-point. The method comprises implementing at a processor implemented server, the steps of (i) initiating a primary display datastream transmission session with the display end-point, (ii) initiating a secondary interactive display data stream transmission session with the display end point, (iii) receiving display data corresponding to the primary display datastream, (iv) receiving display data corresponding to the secondary interactive display datastream, (v) implementing simultaneous display of first video content corresponding to the primary display datastream and second video content corresponding to the secondary interactive display data stream on a display device associated with the display end point, wherein the first video content is displayed in a first region of the display device and the second video content is displayed in a second region of the display, (vi) receiving from the display end-point, one or more user input control signals, and (vii) implementing video content delivery control of the secondary interactive display datastream based on the received user input control signals.

In a method embodiment, video content within the primary display datastream is different from video content within the secondary interactive display data stream.

In another embodiment of the method, (i) the primary display datastream is an interactive display datastream, wherein between initiation and termination of the primary interactive display datastream transmission session, selection of video content within the primary display datastream is dependent on user inputs received through the display end-point, or (ii) the primary display datastream is a non-interactive datastream, wherein between initiation and termination of the primary display datastream transmission session, selection of video content for delivery to the display end-point is independent of user inputs received through the display end-point.

In a further method embodiment, (i) the secondary interactive display datastream is a videostream corresponding to a computing device implemented gameplay session, and (ii) between initiation and termination of the secondary interactive display datastream transmission session, selection of video content within the secondary interactive display datastream is dependent on gameplay related user inputs received through the display end-point

In a particular embodiment of the method the first region and the second region of the display device overlap at least partially on the display,

In an embodiment, the method may further comprise rendering on the display, one or more controls configured to enable a user to interact with the secondary interactive display data stream.

In a specific embodiment of the method, (i) the secondary interactive display datastream is a videostream corresponding to a computing device implemented gameplay session, (ii) implementing video content delivery control of the secondary interactive display datastream based on the received user input control signals comprises implementing one or more gameplay state changes based on the received user input control signals, and (iii) said one or more gameplay state changes includes selecting or controlling video content for display at the display end-point, within the secondary interactive display datastream.

The invention additionally provides a system for delivering videostream data at a display end-point. The system comprises a memory, and a processor configured to (i) initiate a primary display datastream transmission session with the display end-point, (II) initiate a secondary interactive display data stream transmission session with the display end point, (iii) receive display data corresponding to the primary display datastream, (iv) receive display data corresponding to the secondary interactive display datastream, (v) implement simultaneous display of first video content corresponding to the primary display datastream and second video content corresponding to the secondary interactive display data stream on a display device associated with the display end point, wherein the first video content is displayed in a first region of the display device and the second video content is displayed in a second region of the display, (vi) receive from the display end-point, one or more user input control signals, and (vii) implement video content delivery control of the secondary interactive display datastream based on the received user input control signals.

The system may be configured such that video content within the primary display datastream is different from video content within the secondary interactive display data stream.

In an embodiment, the system may be configured such that (i) the primary display datastream is an interactive display datastream, wherein between initiation and termination of the primary interactive display datastream transmission session, selection of video content within the primary display datastream is dependent on user inputs received through the display end-point, or (ii) the primary display datastream is a non-interactive datastream, wherein between initiation and termination of the primary display datastream transmission session, selection of video content for delivery to the display end-point is independent of user inputs received through the display end-point.

The system may be configured such that (i) the secondary interactive display datastream is a videostream corresponding to a computing device implemented gameplay session, and (ii) between initiation and termination of the secondary interactive display datastream transmission session, selection of video content within the secondary interactive display datastream is dependent on gameplay related user inputs received through the display end-point.

In another embodiment the system may be configured such that the first region and the second region of the display device overlap at least partially on the display.

The system may be configured to render on the display, one or more controls configured to enable a user to interact with the secondary interactive display data stream,

The system may be configured such that (i) the secondary interactive display datastream is a videostream corresponding to a computing device implemented gameplay session, (ii) implementing video content delivery control of the secondary interactive display datastream based on the received user input control signals comprises implementing one or more gameplay state changes based on the received user input control signals, and (iii) said one or more gameplay state changes includes selecting or controlling video content for display at the display end-point, within the secondary interactive display datastream.

The invention additionally provides a computer program product for delivering videostream data at a display end-point. The computer program product comprises a non-transitory computer usable medium having computer readable program code embodied therein, the computer readable program code comprising instructions for implementing at a processor, the steps of (i) initiating a primary display datastream transmission session with the display end-point, (ii) initiating a secondary interactive display data stream transmission session with the display end point, (iii) receiving display data corresponding to the primary display datastream, (iv) receiving display data corresponding to the secondary interactive display datastream, (v) implementing simultaneous display of first video content corresponding to the primary display datastream and second video content corresponding to the secondary interactive display data stream on a display device associated with the display end point, wherein the first video content is displayed in a first region of the display device and the second video content is displayed in a second region of the display, (vi) receiving from the display end-point, one or more user input control signals, and (vii) implementing video content delivery control of the secondary interactive display datastream based on the received user input control signals.

### BRIEF DESCRIPTION OF THE ACCOMPANYING DRAWINGS

FIG. 1 illustrates an exemplary system environment that enables streaming of display data to a plurality of viewers display end-points.

FIGS. 2A and 2B illustrate exemplary instances of display datastreams of types that may be streamed to one or more display end-points.

FIG. 3 illustrates a system environment configured in accordance with the teachings of the present invention

FIG. 4 illustrates an exemplary instance of an interactive video game/computer game of a kind that can be used to generate a secondary interactive display datastream that can be integrated with a primary display datastream in accordance with the teachings of the present invention.

FIGS. 5A and 5B illustrate exemplary instances of a secondary interactive display datastream that have been integrated with a primary display datastream in accordance with the teachings of the present invention.

FIG. 5C is a flowchart illustrating a method in accordance with the teachings of the present invention.

FIG. 6 illustrates a streaming server configured to implement the teachings of the present invention.

FIG. 7 illustrates an exemplary system for implementing the present invention.

### DETAILED DESCRIPTION

The invention provides methods, systems and computer program products for displaying at one or more display end-points, an integrated display that is generated based on a primary display datastream and a secondary interactive display datastream.

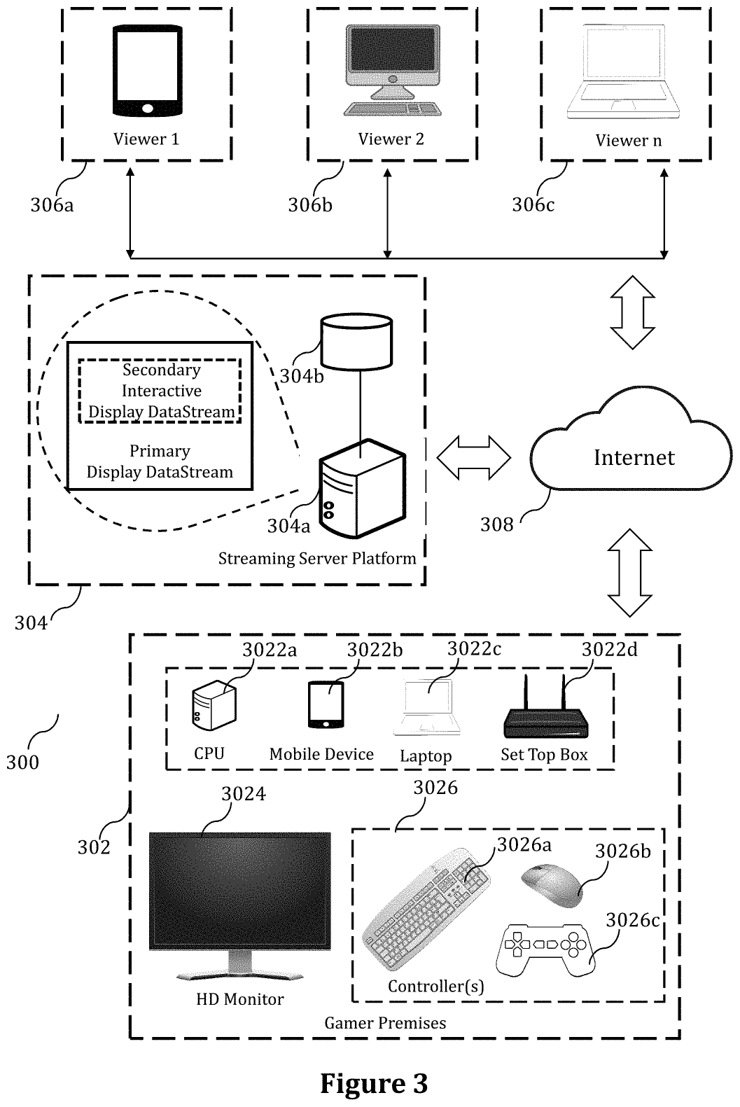

FIG. 3A illustrates a system environment 300 configured in accordance with the teachings of the present invention. As shown in FIG. 3A, system environment 300 comprises at least a streaming server platform 304, configured to broadcast one or more display datastream through the internet 308 (or any other data network) to one or more viewers/display end-points 306a, 306b, 306c (each broadcast end-points comprising a display device controlled by one of viewer 1, viewer 2, upto viewer n).

Streaming server platform 304 may comprise a streaming server 304a configured to (i) receive display data such as video data or videostream data from a display data source, (ii) generate and maintain a data channel to each of display end-points 306a to 306c, (iii) transmit the display data to each display end-point 306a to 306c over the corresponding data channel.

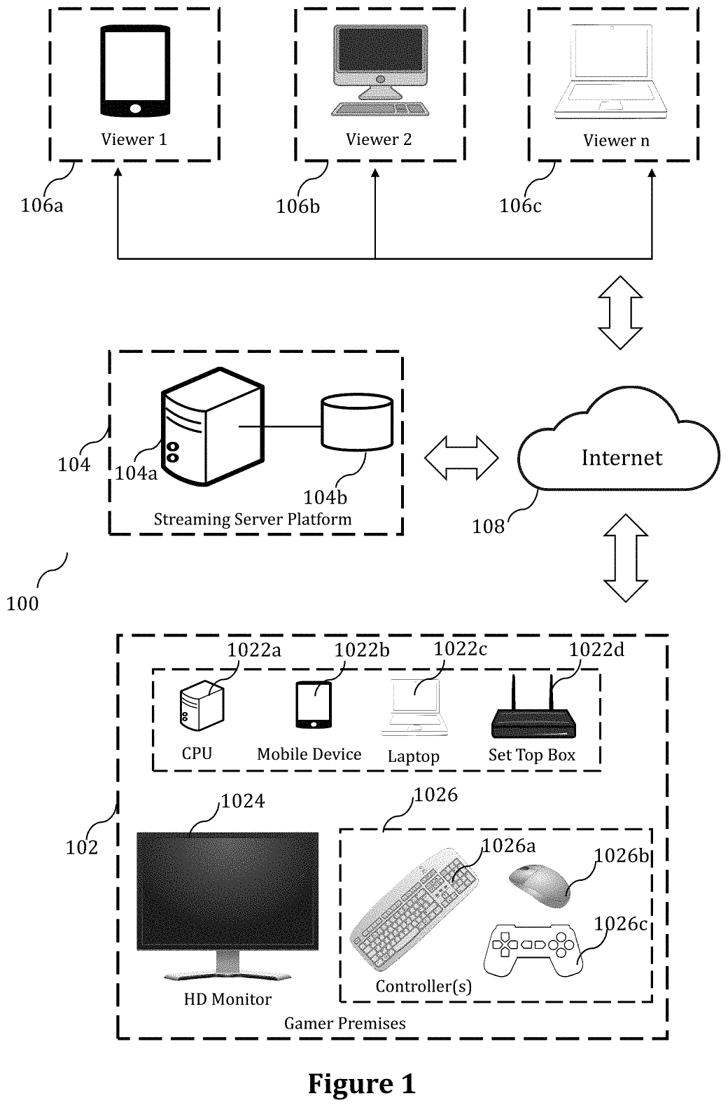

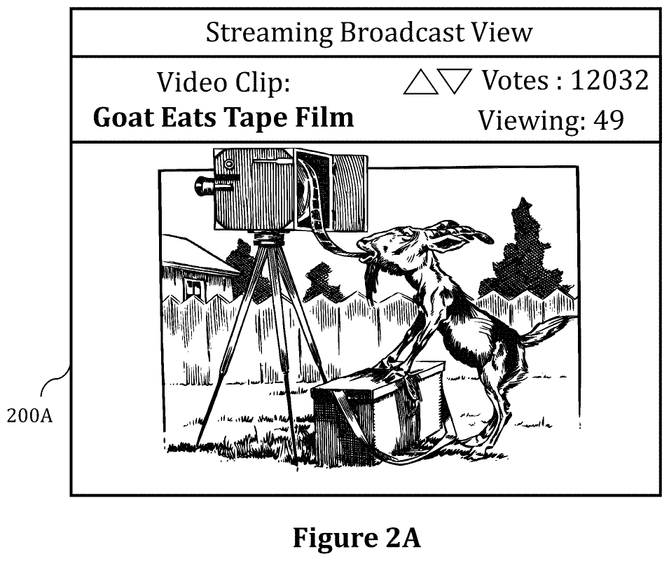

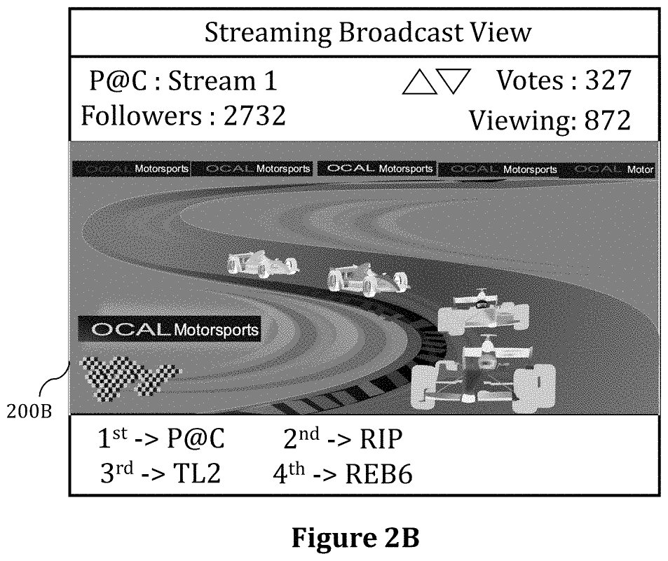

As in the case of FIG. 1, streaming server 304a may be configured to stream to one or more display end-points 306a to 306c, a primary display datastream comprising video data retrieved from a database, or from a live video data source such as one or more cameras and/or gaming devices operated by a gamer who has opted to stream her/his gameplay data. Yet further, streaming server 304a is configured to simultaneously stream to the same one or more display end-points 306a to 306c, a secondary interactive display datastream.

The primary display datastream and the secondary interactive display datastream are streamed to each of the one or more display end-points 306a to 306c in a manner that ensures that display data video data corresponding to the primary display datastream is displayed in a first portion of a display associated with a display end-point, while display data/video data corresponding to the secondary interactive display datastream is displayed in a second portion of a display associated with said display end-point.

The relative location of display data corresponding respectively to each of the primary display datastream and the secondary interactive display datastream on the display end-point may be controlled by one or more of a software application or software instructions implemented at the display end-point, a software application or software instructions implemented at the streaming server 304a, and/or a software application or software instructions implemented at the display data source (e.g. at the database, or from a live video data source from which the display data is received).

For the purposes of the invention, a display associated with a display end-point may comprise any display device integrated or communicably coupled with any display end-point 306a to 306b.

For the purposes of the invention, the term “interactive display datastream” refers to a display datastream where one or more of content, data or outcomes associated with said display datastream are determined based on user inputs received through one or more display end-points to which said display datastream is being transmitted, and displayed on. In an embodiment, an interactive display datastream may comprise a video game or computer game of a kind where the outcomes are controlled by user inputs received at a computing device on which display data associated with the video game/computer game is displayed.

For the purposes of the invention, the ‘primary display datastream’ may he understood to comprise any videostream wherein between initiation and termination of a datastream transmission session associated with transmission of said primary display datastream, selection of video content for delivery to the display end-point within the videostream is independent of user inputs received from or through the display end-point.

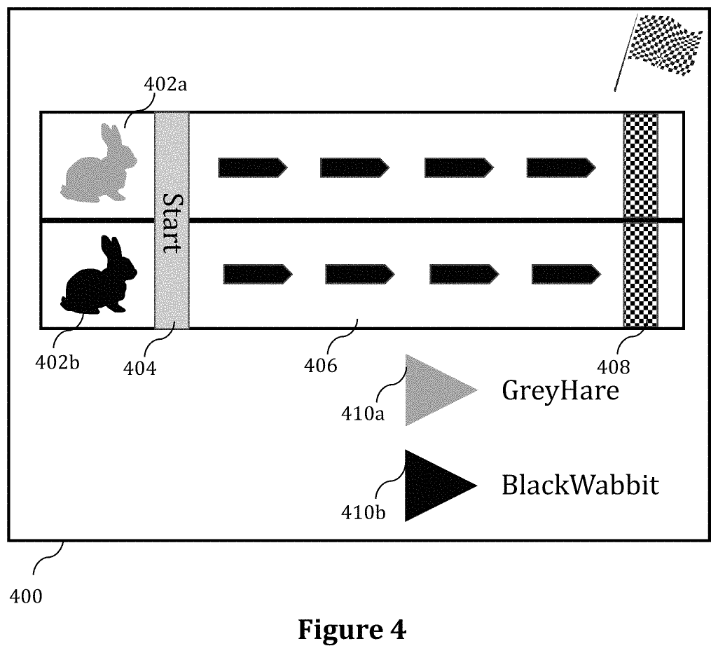

FIG. 4 illustrates an exemplary instance of a video game computer game of a kind that can be used to generate a secondary interactive display datastream that may be integrated with a primary display datastream in accordance with the teachings of the present invention. The exemplary video game/computer game shown in FIG. 4 comprises a head to head race type game between players, each controlling one of two rabbits 402, 402b, using corresponding controls 410a, 410b to try and advance their respective rabbits along a race track 406 and first across the finish line 408. It will be understood that the illustrated instance is only exemplary, and any other form of interactive video games/computer games/interactive display content can also be used to generate a secondary interactive display datastream.

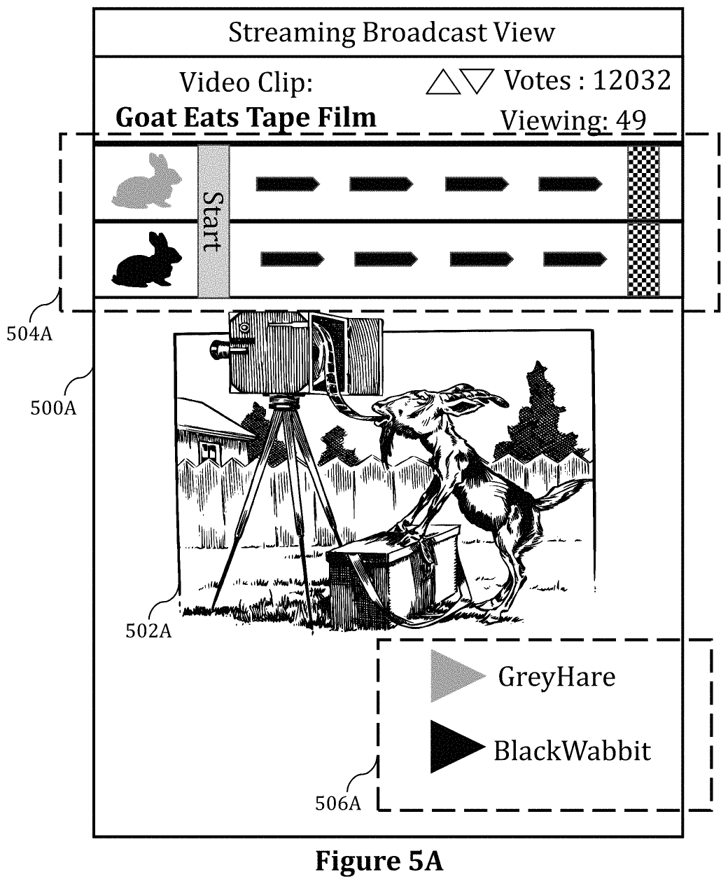

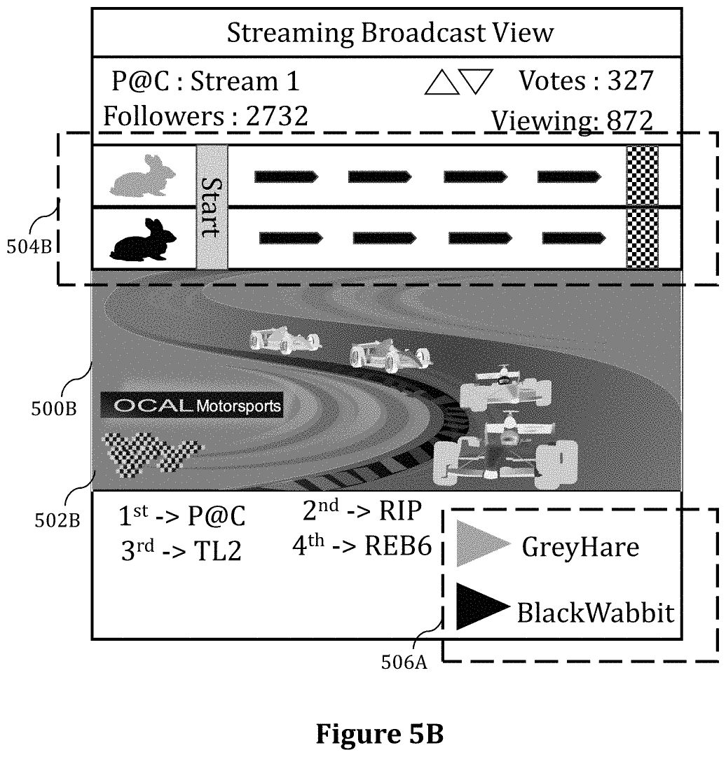

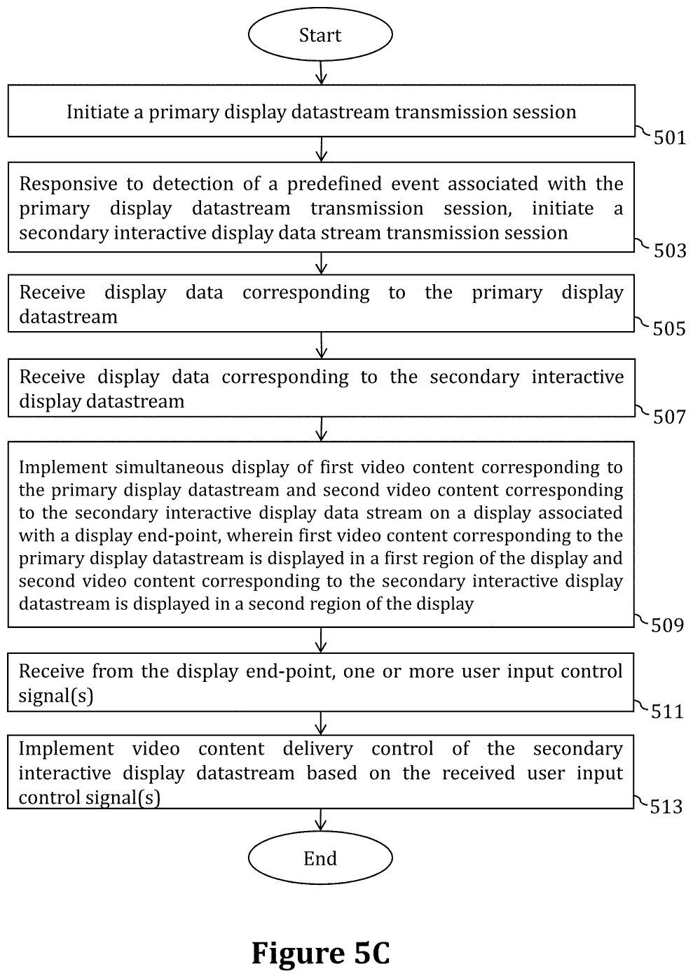

FIG. 5A illustrates an exemplary instances of a secondary interactive display datastream (comprising display data from the exemplary video game/computer game shown in FIG. 4), that has been integrated with a primary display datastream, each of which has been received at a display end-point from streaming server 304a in accordance with the teachings of the present invention. As shown in FIG. 5A, an integrated display 500A is generated for display on each of one or more display end-points 306a to 306c-wherein the integrated display datastream 500A simultaneously comprises (i) display data from a primary display datastream comprising a datastream of a video clip of a goat eating video film, and (ii) secondary interactive display data from the exemplary video game/computer game of FIG. 4—comprising a head to head race type game between players, each controlling one of two rabbits, using controls 506A to try and advance their respective rabbits along a race track and first across the finish line.

As shown, display data from the primary display datastream is displayed on a first portion 502A of the display, while display data from the secondary interactive display datastream is displayed on at least a second portion 504A, 506A of the display. In certain embodiments, the first portion of the display and the second portion of the display may overlap at least partially and in a specific embodiment, at least part of one of the primary display datastream and the secondary interactive display datastream overlays the other. As shown in FIG. 5A, in an embodiment, the display data from the secondary interactive display datastream may be split into at least two distinct portions 504A, 506A, which may be contiguously or non-contiguously displayed on each display respectively associated with each of the one or more display end-points 306a to 306c.

The integration and/or relative location of display data corresponding to each of the primary display datastream and the secondary interactive display datastream on the display end-point may be controlled by one or more of a software application or software instructions implemented at the display end-point, a software application or software instructions implemented at the streaming server 304a, and/or a software application or software instructions implemented at the display data source (e.g. at the database, or from a live video data source from which the display data is received).

FIG. 5B illustrates another exemplary instances of display data from a secondary interactive display datastream based on the exemplary video game/computer game shown in FIG. 4, that has been integrated with display data from a primary display datastream, in accordance with the teachings of the present invention. As shown in FIG. 5B, streaming server 304a generates an integrated display data stream 5001 for display on each of one or more display end-points 306a to 306c—wherein the integrated display datastream 5001 simultaneously comprises (i) display data from a primary display datastream comprising a gameplay video datastream of a racing game from a gamer streaming under the online name “P@C”, and (ii) display data from a secondary interactive display datastream from the exemplary video game/computer game of FIG. 4—comprising a head to head race type game between players, each controlling one of two rabbits, using controls 506B to try and advance their respective rabbits along a race track and first across the finish line. As shown, display data from the primary display datastream is displayed at a first portion 502B of the display, while display data from the secondary interactive display datastream is displayed on at least a second portion 504B, 506B of the display. In certain embodiments, the first portion of the display and the second portion of the display may overlap at least partially—and in a specific embodiment, at least part of one of the primary display datastream and the secondary interactive display datastream overlays the other. As shown in FIG. 5B, in an embodiment, the display data from the secondary interactive display datastream may be split into at least two distinct portions 504B, 506B, which may be contiguously or non-contiguously displayed on each display respectively associated with each of the one or more display end-points 306a to 306c.

The integration and/or relative location of display data corresponding to each of the primary display datastream and the secondary interactive display datastream on the display end-point may be controlled by one or more of a software application or software instructions implemented at the display end-point, a software application or software instructions implemented at the streaming server 304a, and/or a software application or software instructions implemented at the display data source (e.g. at the database, or from a live video data source from which the display data is received).

The respective locations and manner in which display, data corresponding to each of the primary display datastream and the secondary interactive display, datastream are displayed on a display may depend on any one or more of (i) display, end-point settings, (ii) viewer preferences, (iii) one or more streaming server settings, and f or (iv) preferences or profile information of a gamer or video content developer/broadcaster associated with the primary display data stream.

In an embodiment of the invention, user input/user input based control signals received from each display end-point 306a to 306c at which the primary display datastream and the secondary interactive display datastream are simultaneously displayed, may be used to control subsequently displayed content or subsequent display outcomes of the secondary interactive display datastream.

In an embodiment, the primary display datastream is not an interactive display data stream. In another embodiment, both of the primary display datastream and the secondary interactive display datastream are interactive display data streams.

It will be understood from the illustrations of FIGS. 5A and 5B that integrating display data from the primary display data stream and the secondary interactive display data stream for display on a display end-point may additionally include rendering (at such display endpoints) controls that a viewer can use to interact with the secondary interactive display data stream. For example, where the secondary interactive display datastream comprises the rabbit racing game of FIG. 4, the integrated display also incorporates controls that allow viewers to incrementally move a rabbit by clicking a control associated with the rabbit. Each viewer click or user activation of a control associated with a first rabbit may be used to incrementally advance the first rabbit towards the finish line, while each viewer click or user activation of a control associated with a second rabbit may be used to incrementally advance the second rabbit towards the finish line. In an embodiment, the aggregation of viewer clicks associated with each of the first and second rabbits, received across each display end-point 306a to 306c at which the secondary interactive display datastream is displayed determines the eventual outcome of the race (i.e. which of the first and second rabbits wins the race)—and the race progress is displayed to all receiving display end-points or all participating display end-points in real time.

By allowing viewers to actually participate in controlling the outcomes or content of the secondary interactive display datastream, the viewers are kept engaged—while simultaneously enabling them to follow progress of the primary display datastream within the same display/display end-point. In some embodiments, viewers interacting with the secondary interactive display datastream may receive prizes, rewards or other benefits based on their performance. In other embodiments, users may be permitted to wager on future outcomes of the one or both of the primary display datastream and/or a secondary interactive display datastream.

FIG. 5C is a flowchart illustrating a method in accordance with the teachings of the present invention. The method of FIG. 5C may be implemented either at a streaming server, or at a display endpoint of the kind described above.

Step 501 comprises initiating a primary display datastream transmission session between a server and a display end-point. The primary display datastream transmission session may be initiated in response to detection of a session initiation event or a session initiation action initiated either at the server or at the display end-point. Initiating the primary display datastream transmission session may comprise initiating transmission of a primary display datastream from the server to the display end-point, for rendering on a display coupled with the display end-point. In an embodiment, the primary display datastream comprises a videostream. In another embodiment, the primary display datastream may comprise an interactive display data stream. In another embodiment, the primary display datastream is a non-interactive videostream i.e, the primary display datastream comprises a videostream wherein between initiation and termination of the primary display datastream transmission session, selection of video content for delivery to the display end-point is independent of user inputs received from or through the display endpoint.

Step 503 comprises responding to detection of a predefined event associated with the primary display datastream transmission session, by initiating a secondary interactive display data stream transmission session. The predefined event may comprise any predefined state change event, and in a preferred embodiment may comprise receiving a user input at or through the display end-point, wherein the received user-input is associated with initiating a secondary interactive display data stream transmission session. Initiating the secondary interactive display datastream transmission session comprises initiating transmission of a secondary display datastream from the server to the display end-point, for rendering on a display coupled with the display end-point. In an embodiment, the secondary interactive display datastream comprises an interactive videostream i.e. the secondary interactive display datastream comprises a videostream wherein between initiation and termination of the secondary interactive display datastream transmission session, selection of video content within the videostream is dependent on user inputs received from or through the display end-point. In a more particular embodiment, the secondary interactive display datastream comprises a videostream corresponding to a gameplay session wherein user inputs received from or through the display end-point between initiation and termination of the secondary interactive display datastream transmission session are used as inputs for controlling gameplay within the gameplay session.

The primary display datastream transmission session and the secondary interactive display datastream session are each distinct from the other. In an embodiment, initiating the primary display datastream transmission session comprises establishing a first communication channel for transmission of the primary display datastream to the display end-point, and initiating the secondary interactive display datastream transmission session comprises establishing a second communication channel for transmission of the secondary interactive display datastream to the display end-point—wherein the first and second communication channels are distinct. In an embodiment where both of the primary display datastream and the secondary interactive display data stream are videostreams, video content within the primary display datastream is different from video content within the secondary interactive display data stream.

Step 505 comprises receiving display data corresponding to the primary display datastream. In an embodiment where the primary display datastream is a videostream, the received display data may comprise video content corresponding to such videostream.

Step 507 comprises receiving display data corresponding to the secondary interactive display datastream. In an embodiment where the secondary interactive display datastream is a videostream, the received display data may comprise video content corresponding to such videostream. In an embodiment where the secondary interactive display datastream comprises a videostream corresponding to a gameplay session, the received display data may comprise video gameplay data.

Step 509 comprising implementing simultaneous display of first video content corresponding to the primary display datastream and second video content corresponding to the secondary interactive display data stream on a display associated with the display end-point. The first video content corresponding to the primary display datastream is displayed in a first region of the display and the second video content corresponding to the secondary interactive display datastream is displayed in a second region of the display. The first and second regions may overlap at least partially on the display—and in a preferred embodiment, at least part of one of the primary display datastream and the secondary interactive display datastream overlays the other. Further, in certain embodiments, the second video content from the secondary interactive display datastream may be split into at least two distinct portions which may be contiguously or non-contiguously displayed on a display associated with the display end-point.

In an embodiment, step 509 may additionally include rendering, on the display associated with the display end-point, one or more controls that a viewer can use to interact with the secondary interactive display data stream.

The respective locations and manner in which video content corresponding to each of the primary display datastream and the secondary interactive display datastream are displayed on a display may depend on any one or more of (i) display end-point settings, (ii) viewer preferences, (iii) one or more streaming server settings, and/or (iv) preferences or profile information of a garner or video content developer broadcaster associated with the primary display data stream.

Step 511 comprises receiving from the display end-point, one or more user input control signal(s). The one or more user input control signal(s) may comprise control signals generated in response to a user selecting or activating a hardware or a software control that is coupled with or implemented by or within the display end-point. In an embodiment where the secondary interactive display data stream comprises a videostream corresponding to a gameplay session, the received one or more control signal(s) may comprise control signals that a software application, that is implementing gameplay corresponding to the gameplay session, is configured to recognize as valid gameplay related user input signal(s).

Step 513 comprises implementing video content delivery control of the secondary interactive display datastream based on the received user input control signal(s). In an embodiment, step 513 comprises selecting or controlling video content for transmission or delivery to, or display at the display end point, within the secondary interactive display datastream, wherein said selection is based on the received user input control signal(s). In an embodiment where the secondary interactive display datastream comprises a videostream corresponding to a gameplay session, step 513 may comprise implementing one or more gameplay state changes based on the received user input control signal(s)—wherein said one or more gameplay state changes includes selecting or controlling video content for transmission or delivery to, or display at the display end point, within the secondary interactive display datastream.

In an embodiment of the invention, step 513 may comprise utilizing user input user input based control signals received at step 511, to control subsequently displayed content or subsequent display outcomes of the secondary interactive display datastream.

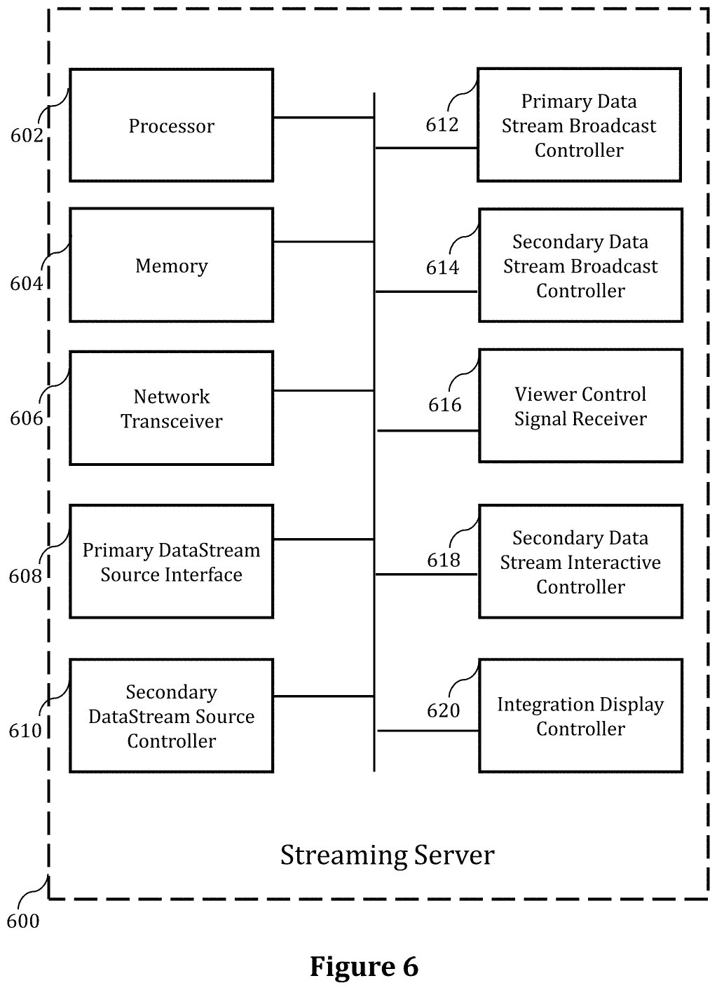

FIG. 6 illustrates an embodiment of a streaming server 600 configured to implement the teachings of the present invention. In an embodiment, the streaming server 600 is configured to implement the method steps illustrated and described in connection with FIG. 5C above.

Streaming server 600 may comprise one or more of (i) a processor 602 configured for data processing operations within streaming server 600, (ii) a memory 604, which memory 604 includes transitory memory and/or non-transitory memory, (iii) a network transceiver 606 configured to enable streaming server 600 to send and receive network based data communications, (iv) a primary datastream source interface 608 configured to enable streaming server 600 to interface with a source of the primary display datastream (for example, with a database of video content/streaming video content or with a camera/gaming device from which gameplay video data is being streamed), (v) a secondary datastream source controller 610 configured to enable streaming server 600 to interface with a source of the secondary interactive display datastream (for example with a game execution server or processor on which code corresponding to the computer game/video game described in connection with FIG. 4 is being executed), (vi) a primary datastream broadcast controller 612 configured to transmit to one or more display end-points, the primary display datastream, (vii) a secondary datastream broadcast controller 614 configured to transmit the secondary interactive display datastream to the one or more display end-points (viii) a viewer control signal receiver 616 configured to receive from the one or more display end-points, interactive data input by viewers at the one or more display end-points, through one or more controls provided at said display end-points, (ix) a secondary datastream interactive controller 618 configured to use the interactive data input that is received through the viewer control signal receiver, for controlling subsequent content/outcomes of the secondary interactive display datastream that is transmitted to the one or more display end-points, and (x) an integration display controller 620 configured to control the simultaneous rendering (for example the display positions) of display data from the primary display datastream and from the secondary interactive display datastream, on each display associated respectively with the one or more display end-points to which the primary and secondary datastreams are transmitted by streaming server 600.

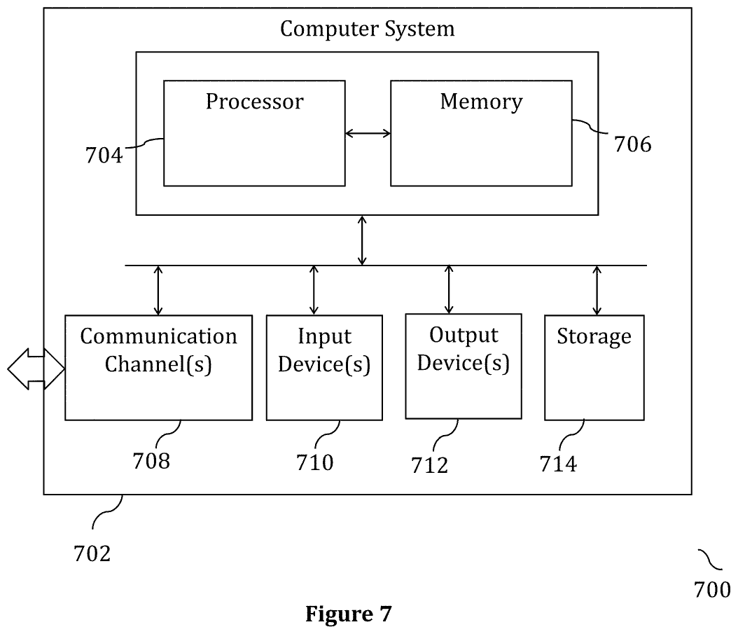

FIG. 7 illustrates an exemplary system 700 for implementing the present invention. The illustrated system 700 comprises computer system 702 which in turn comprises one or more processors 704 and at least one memory 706. Processor 704 is configured to execute program instructions—and may be a real processor or a virtual processor. It will be understood that computer system 702 does not suggest any limitation as to scope of use or functionality of described embodiments. The computer system 702 may include, but is not be limited to, one or more of a general-purpose computer, a programmed microprocessor, a micro-controller, an integrated circuit, and other devices or arrangements of devices that are capable of implementing the steps that constitute the method of the present invention.

Exemplary embodiments of a computer system 702 in accordance with the present invention may include one or more servers, desktops, laptops, tablets, smart phones, mobile phones, mobile communication devices, tablets, phablets and personal digital assistants. In an embodiment of the present invention, the memory 706 may store software for implementing various embodiments of the present invention. The computer system 702 may have additional components. For example, the computer system 702 may include one or more communication channels 708, one or more input devices 710, one or more output devices 712, and storage 714. An interconnection mechanism (not shown) such as a bus, controller, or network, interconnects the components of the computer system 702. In various embodiments of the present invention, operating system software (not shown) provides an operating environment for various softwares executing in the computer system 702 using a processor 704, and manages different functionalities of the components of the computer system 702.

The communication channel(s) 708 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 710 may include, but is not limited to, a touch screen, a keyboard, mouse, pen, joystick, trackball, a voice device, a scanning device, or any another device that is capable of providing input to the computer system 702. In an embodiment of the present invention, the input device(s) 710 may be a sound card or similar device that accepts audio input in analog or digital form. The output device(s) 712 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 702.

The storage 714 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 702. In various embodiments of the present invention, the storage 714 may contain program instructions for implementing any of the described embodiments.

In an embodiment of the present invention, the computer system 702 is part of a distributed network or a part of a set of available cloud resources,

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 702. The method described herein is typically implemented as a computer program product, comprising a set of program instructions that is executed by the computer system 702 or any other similar device. The set of program instructions may be a series of computer readable codes stored on a tangible medium, such as a computer readable storage medium (storage 714), for example, diskette, CD-ROM, ROM, flash drives or hard disk, or transmittable to the computer system 702, via a modem or other interface device, over either a tangible medium, including but not limited to optical or analogue communications channel(s) 708. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it will be understood that the invention provides methods, systems and computer program products for generating and displaying at one or more display end-points, an integrated display that is generated based on a primary display datastream and a secondary, interactive display datastream. The invention accordingly enables involving viewers of a display datastream in one or more interactive activities that promote viewer engagement and participation while simultaneously enabling the viewer to continue to view the display datastream.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein and in a particular embodiment specifically contemplated, is intended to be practiced in the absence of any element which is not specifically disclosed herein.

We claim:

1. A method for delivering videostream data at a display end-point, the method comprising implementing at a processor implemented server, the steps of:
initiating a primary display datastream transmission session with the display end-point;
initiating a secondary interactive display data stream transmission session with the display end point;
receiving display data corresponding to the primary display datastream;
receiving display data corresponding to the secondary interactive display datastream;
implementing simultaneous display of first video content corresponding to the primary display datastream and second video content corresponding to the secondary interactive display data stream on a display device associated with the display end point, wherein the first video content is displayed in a first region of the display device and the second video content is displayed in a second region of the display;
receiving from the display end-point, one or more user input control signals;
implementing video content delivery control of the secondary interactive display datastream based on the received user input control signals.

2. The method as claimed in claim 1, wherein video content within the primary display datastream is different from video content within the secondary interactive display data stream.

3. The method as claimed in claim 1 wherein:
the primary display datastream is an interactive display datastream, wherein between initiation and termination of the primary interactive display datastream transmission session, selection of video content within the primary display datastream is dependent on user inputs received through the display end-point; or
the primary display datastream is a non-interactive datastream, wherein between initiation and termination of the primary display datastream transmission session, selection of video content for delivery to the display endpoint is independent of user inputs received through the display endpoint.

4. The method as claimed in claim 1 wherein:
the secondary interactive display datastream is a videostream corresponding to a computing device implemented game play session; and
between initiation and termination of the secondary interactive display datastream transmission session, selection of video content within the secondary interactive display datastream is dependent on gameplay related user inputs received through the display end-point.

5. The method as claimed in claim 1, wherein the first region and the second region of the display device overlap at least partially on the display.

6. The method as claimed in claim 1, further comprising rendering on the display, one or more controls configured to enable a user to interact with the secondary interactive display data stream.

7. The method as claimed in claim 1, wherein:
the secondary interactive display datastream is a videostream corresponding to a computing device implemented gameplay session;
implementing video content delivery control of the secondary interactive display datastream based on the received user input control signals comprises implementing one or more gameplay state changes based on the received user input control signals; and
said one or more gameplay state changes includes selecting or controlling video content for display at the display end-point, within the secondary interactive display datastream.

8. A system for delivering videostream data at a display end-point, the system comprising:
a memory;
a processor configured to:
initiate a primary display datastream transmission session with the display end-point;
initiate a secondary interactive display data stream transmission session with the display end point;
receive display data corresponding to the primary display datastream;
receive display data corresponding to the secondary interactive display datastream;
implement simultaneous display of first video content corresponding to the primary display datastream and second video content corresponding to the secondary interactive display data stream on a display device associated with the display end point, wherein the first video content is displayed in a first region of the display device and the second video content is displayed in a second region of the display;
receive from the display end-point, one or more user input control signals;
implement video content delivery control of the secondary interactive display datastream based on the received user input control signals.

9. The system as claimed in claim 8, configured such that video content within the primary display datastream is different from video content within the secondary interactive display data stream.

10. The system as claimed in claim 8, configured such that:
the primary display datastream is an interactive display datastream, wherein between initiation and termination of the primary interactive display datastream transmission session, selection of video content within the primary display datastream is dependent on user inputs received through the display end-point; or
the primary display datastream is a non-interactive datastream, wherein between initiation and termination of the primary display datastream transmission session, selection of video content for delivery to the display end-point is independent of user inputs received through the display end-point.

11. The system as claimed in claim 8, configured such that;
the secondary interactive display datastream is a videostream corresponding to a computing device implemented gameplay session; and
between initiation and termination of the secondary interactive display datastream transmission session, selection of video content within the secondary interactive display datastream is dependent on gameplay related user inputs received through the display end-point.

12. The system as claimed in claim 8, configured such that the first region and the second region of the display device overlap at least partially on the display.

13. The system as claimed in claim 8, configured to render on the display, one or more controls configured to enable a user to interact with the secondary interactive display data stream.

14. The system as claimed in claim 8, configured such that:
the secondary interactive display datastream is a videostream corresponding to a computing device implemented gameplay session;
implementing video content delivery control of the secondary interactive display datastream based on the received user input control signals comprises implementing one or more gameplay state changes based on the received user input control signals; and
said one or more gameplay state changes includes selecting or controlling video content for display at the display end-point, within the secondary interactive display datastream.

15. A computer program product for delivering videostream data at a display end-point, the computer program product comprising a non-transitory computer usable medium having computer readable program code embodied therein, the computer readable program code comprising instructions for implementing at a processor, the steps of:
initiating a primary display datastream transmission session with the display end-point;
initiating a secondary interactive display data stream transmission session with the display end point;
receiving display data corresponding to the primary display datastream;
receiving display data corresponding to the secondary interactive display datastream;
implementing simultaneous display of first video content corresponding to the primary display datastream and second video content corresponding to the secondary interactive display data stream on a display device associated with the display end point, wherein the first video content is displayed in a first region of the display device and the second video content is displayed in a second region of the display;
receiving from the display end-point, one or more user input control signals; and
implementing video content delivery control of the secondary interactive display datastream based on the received user input control signals.
